(19) United States
(12) Patent Application Publication
(10) Pub. No.: US 2011/0171045 A1
(43) Pub. Date: Jul. 14, 2011

(54) PRESSURE WASHER PUMP

(75) Inventors: Richard J. Gilpatrick, Whitewater, WI (US); Ron Kassner, Edgerton, WI (US)

(73) Assignee: Briggs & Stratton Corporation

(21) Appl. No.: 12/687,774

(22) Filed: Jan. 14, 2010

(51) Int. Cl. F04B 27/04; F04B 37/12; B23P 11/00

(52) U.S. Cl. 417/273; 417/471; 417/521; 29/888.02

(57) ABSTRACT

A high-pressure water pump for a pressure washer system includes an elliptical cam, a piston, and an unloader. The elliptical cam is designed to be powered by a prime mover, and is rotatable between a first orientation and a second orientation. The piston is designed to be driven within a chamber by the elliptical cam. During operation of the water pump, a flow of water enters the chamber through an inlet when the elliptical cam rotates to the first orientation. The flow of water exits the chamber at an increased pressure through an outlet when the elliptical cam rotates to the second orientation. The flow of water then exits the water pump through the unloader, which is designed to control pressure fluctuations in the flow of water, and is attached to the outlet of the chamber.

### BACKGROUND

The present disclosure relates generally to the field of pressure washers. More specifically, the present disclosure relates to a high-pressure water pump for a pressure washer system.

A pressure washer system includes a high-pressure water pump powered by a prime mover. The high-pressure water pump is typically a positive displacement pump, such as an axial cam pump or a radial cam pump (e.g. triplex pump). Cams within the water pump drive pistons that pressurize a flow of water. High-pressure water pumps are structurally robust in order to support internal water pressures that may exceed 2000 pounds per square inch (psi). For example, some pressure washer pumps employ cloth-impregnated rubber seals to prevent leakage between components exposed to the high-pressure water. Additionally the torque necessary to drive a pressure washer pump and to generate the high-pressure water flow may be provided by an engine, such as a single-cylinder, vertically-shafted, four-stroke cycle, internal combustion engine. The engine may be coupled directly to the water pump such that a power take-off of the engine rotates the cams of the water pump.

### SUMMARY

One embodiment of the invention relates to a high-pressure water pump for a pressure washer system. The water pump includes an elliptical cam, a piston, and an unloader. The elliptical cam is designed to be powered by a prime mover, and is rotatable between a first orientation and a second orientation. The piston is designed to be driven within a chamber by the elliptical cam. During operation of the water pump, a flow of water enters the chamber through an inlet when the elliptical cam rotates to the first orientation. The flow of water exits the chamber at an increased pressure through an outlet when the elliptical cam rotates to the second orientation. The flow of water then exits the water pump through the unloader, which is designed to control pressure fluctuations in the flow of water, and is attached to the outlet of the chamber.

Another embodiment of the invention relates to water pump. The water pump includes a cam, a compartment in which the cam rotates, a piston, and a bearing. The cam is designed to be powered by a prime mover, and is rotatable between a first orientation and a second orientation. The piston is designed to be driven within a chamber by the cam rotating in the compartment. The compartment contains a lubricant other than oil. The bearing is positioned between the cam and the piston when the cam is in the second orientation.

Yet another embodiment of the invention relates to a method of assembling a water pump for a pressure washer system. The method includes steps of providing a first casting forming a piston housing, providing a second casting forming a head manifold, and providing a third casting forming an unloader. The method also includes steps of fastening the second casting on top of the first casting, and fastening the third casting on top of the second casting. The steps of fastening the second casting and fastening of the third casting do not require reorienting the first casting, the second casting, or the third casting. As such, the orientation of the water pump need not be changed on an assembly line during assembly.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a pressure washer system according to an exemplary embodiment of the invention.

FIG. 2 is a perspective view of a water pump according to an exemplary embodiment of the invention.

FIG. 3 is another perspective view of the water pump of FIG. 2.

FIG. 4 is yet another perspective view of the water pump of FIG. 2.

FIG. 5 is a perspective view of portions of the water pump of FIG. 2.

FIG. 6 is a perspective view of other portions of the water pump of FIG. 2.

FIG. 7 is an exploded view of a water pump according to an exemplary embodiment of the invention.

FIG. 8 is a top view of the water pump of FIG. 7.

FIG. 9 is a sectional view of a portion of the water pump of FIG. 8 taken along the line 9-9.

FIG. 10 is a sectional view of a portion of the water pump of FIG. 8 taken along the line 10-10.

FIG. 11 is a sectional view of a portion of the water pump of FIG. 8 taken along the line 11-11.

FIG. 12 is a schematic view of a cam and pistons of a water pump according to an exemplary embodiment of the invention.

FIG. 13 is a schematic view of a cam and pistons of a water pump according to another exemplary embodiment of the invention.

FIG. 14 is a perspective view of a cam and piston according to an exemplary embodiment of the invention.

FIG. 15 is a perspective view of a cam and piston according to another exemplary embodiment of the invention.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

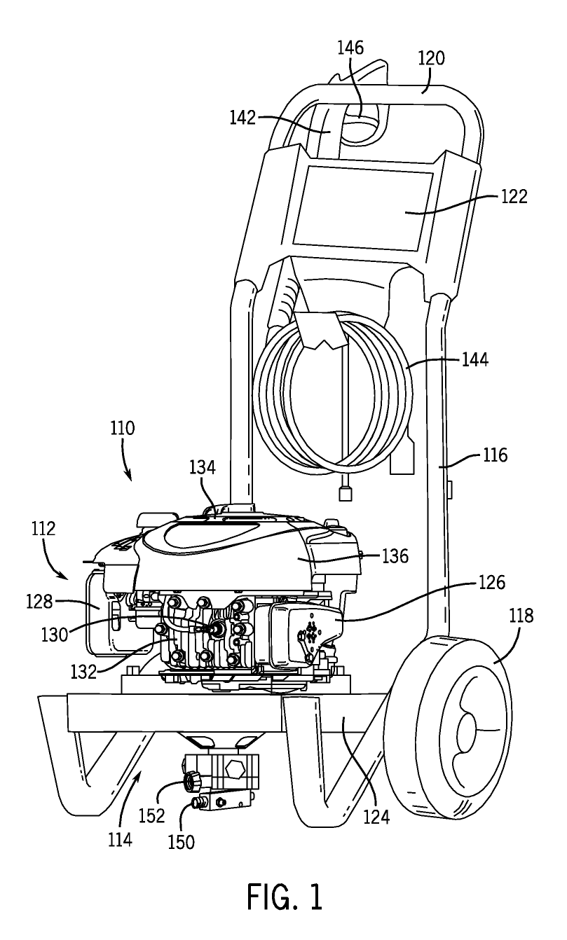

Referring to FIG. 1, a pressure washer system 110 includes a water pump 114 and a prime mover in the form of an internal combustion engine 112. The engine 112 and the water pump 114 are mounted to a support structure 116, which includes wheels 118, a handle 120, a base plate 124, and a billboard 122 (e.g., console, panel, etc.). The internal combustion engine 112 is mounted on top of the base plate 124, and the water pump 114 is mounted beneath the base plate 124. A sprayer, such as a pressure washer spray gun 142 may be coupled to a holster attached to the support structure 116. A high-pressure hose 144 may also be stored on or in the support structure 116.

According to an exemplary embodiment, the internal combustion engine 112 is a small, single-cylinder, gasoline-powered, four-stroke cycle engine having a vertical shaft. The engine 112 further includes a muffler 126, an air intake 128, and a spark plug 130 extending through a cylinder head 132 of the engine block. A recoil starter 134 for the engine 112 is integrated with a cover 136 (e.g., shroud, housing, etc.) on top of the engine 112. In other embodiments, the prime mover includes an electric motor, a diesel engine, a pneumatic motor, a multi-cylinder engine, or another type of motor.

The spray gun 142 is releasably mounted on the support structure 116, and includes a biased trigger 146. The trigger 146 may be pulled to open a valve (not shown) within the spray gun 142, permitting a high-pressure flow of water to flow through and from the spray gun 142. Releasing the trigger 146 stops the flow of water through the spray gun 142 by closing the valve. In some embodiments, the spray gun 142 has multiple flow-rate or spray settings, with some settings producing a tighter flow stream and other settings producing a broader spray. Still other embodiments use other forms of sprayers, such as an automatic sprinkler, a fire hose, etc.

According to an exemplary embodiment, the water pump 114 shown in FIG. 1 is a positive displacement pump, and includes an inlet 150 and an outlet 152. The inlet 150 is designed to be coupled to a water source, such as a bibcock or faucet, and the outlet 152 is designed to be coupled to the spray gun 142 or other sprayer via the high-pressure hose 144. In some embodiments, the water pump 114 may be a triplex water pump (i.e., radial cam with three pistons), a duplex water pump, a four-piston or six-piston radial cam water pump, or another type of pump. Additionally, the concepts disclosed herein may be used with other types of power equipment, such as a garden hose booster pump, a hydraulic fluid pump, pneumatic pump, or another type of power equipment that operates with a pressurized fluid (e.g., air, water, coolant, motor oil, etc.).

According to an exemplary embodiment, the pressure washer system 110 is designed to produce a high-pressure water stream, sufficient for cleaning, stripping, or other operations. During use of the pressure washer system 110, exit pressure of the flow of water exceeds 2000 psi, preferably exceeds 2700 psi, and even more preferably exceeds 3000 psi. However, in other embodiments, exit pressure is less than 2000 psi. In some embodiments, the pressure washer system 110 is designed to produce an exiting water stream having a flow rate exceeding 2 gallons per minute (gpm), preferably exceeding 3 gpm, such as in a range from about 3 to 3.5 gpm. However, in other embodiments the pressure washer system 110 is designed to produces an exiting water stream that has a flow rate less than 2 gpm.

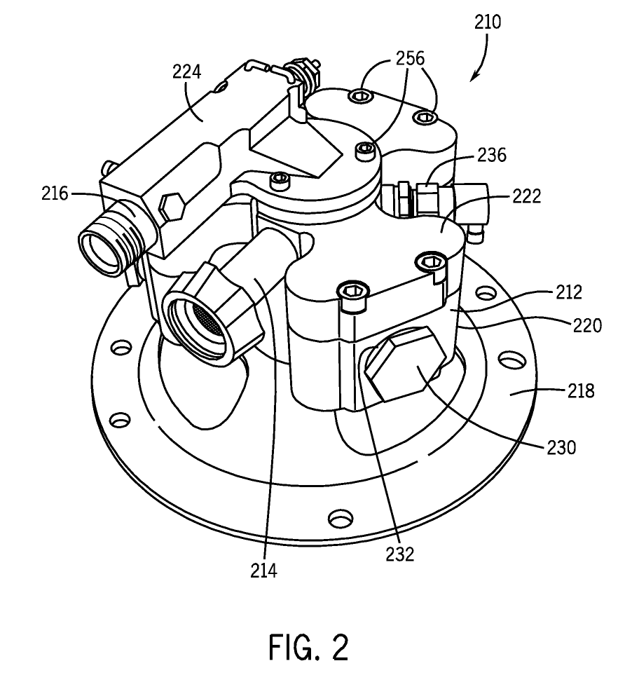

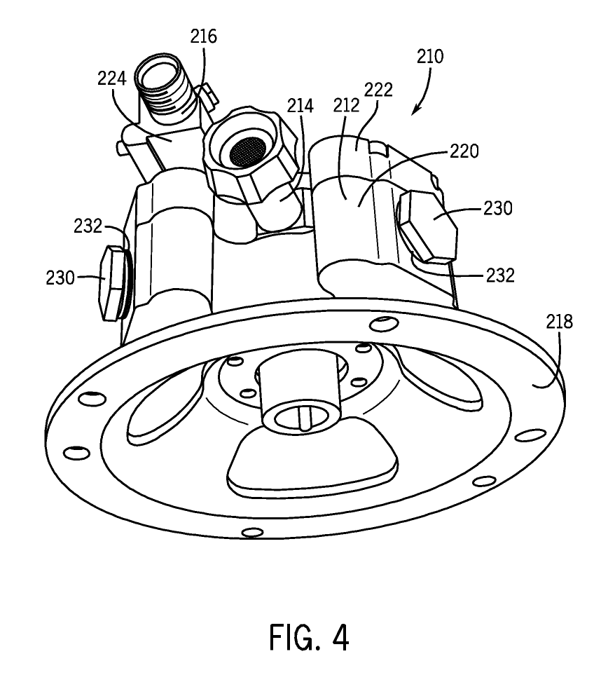

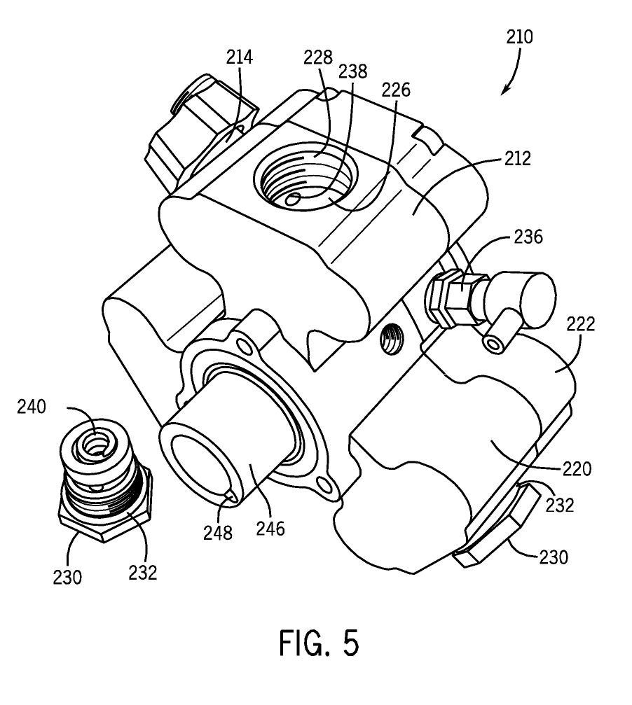

Referring now to FIGS. 2-4, a pump 210 includes a housing 212, an inlet conduit 214, and an outlet conduit 216. An adaptor 218 is designed to facilitate mounting of the pump 210, such as to a base plate of a support structure of a pressure washer system (e.g., base plate 124 as shown in FIG. 1). According to an exemplary embodiment, the housing 212 includes a piston housing 220, a head manifold 222 (e.g., pump head, housing cover, etc.), and a trapped-pressure unloader 224 (e.g., flow-diverting valve). The pump 210 also includes access ports 228 to pumping chambers 226 (see FIG. 5) within the piston housing 220. The access ports 228 are sealed by hex-head bolts 230 having rubber gaskets 232 (or other caps, seals, welds, etc.). The pump 210 has three pumping chambers 226 (see FIG. 5) formed in the piston housing 220. However in other embodiments, water pumps include two to six pumping chambers. In still other embodiments, water pumps include only one pumping chamber, or more than six pumping chambers.

According to an exemplary embodiment, the inlet conduit 214 (e.g., intake conduit) includes a hose connector 234 attached to or integrally formed with an end of the inlet conduit 214. The hose connector 234 may be in the form of a male or female hose connector, and may be designed to couple a garden hose to the pump 210. In some embodiments, the hose connector 234 is a threaded female garden hose coupling. In other embodiments, the hose connector 234 is a female quick-connect coupling. In still other embodiments, the hose connector 234 is another form of commercially-available hose connector, designed to couple the water pump to a conduit (e.g., hose, pipe, channel) that may be connected to a water source, such as an outdoor faucet, a water truck, a water tank, etc.

According to an exemplary embodiment, the flow of water exiting the outlet conduit 216 first passes through the trapped pressure unloader 224. The unloader 224 is designed to control pressure fluctuations in the high-pressure water flow existing the outlet conduit 216. Furthermore, when the pump 210 is running but a sprayer coupled to the outlet conduit 216 is inactive (e.g., spray gun 142 as shown in FIG. 1), the unloader 224 may cut the flow of water to the sprayer and in turn divert the flow of water back through the pump 210 within a recirculation circuit. In some embodiments, the unloader 224 may be additionally used to store and to reuse energy of trapped high-pressure water within a high pressure hose (e.g., hose 144 as shown in FIG. 1) to assist in starting of the prime mover (e.g., engine 112 as shown in FIG. 1).

According to an exemplary embodiment, the pump 210 further includes a thermal relief valve 236. The flow of water in the pump 210 may get too hot, such as when the flow of water is continuously cycling through the recirculation circuit over an extended duration. The thermal relief 236 valve opens to release the hot water, as necessary. In other embodiments, the thermal relief 236 valve is not included, because, for example, the engine may be idled via an idle-control system when the sprayer is inactive.

Still referring to FIGS. 2-4, the unloader 224 is fastened to the head manifold 222. The head manifold 222 is fastened to the piston housing 220. The piston housing 220 is fastened to the adaptor 218. The unloader 224, the head manifold 222, the piston housing 220 may be fastened together by glue, welding, or other fasteners. According to an exemplary embodiment, bolts 256 are used to fasten together the unloader 224, the head manifold 222, and the piston housing 220. The bolts 256 are inserted through bolt holes 258 (e.g., mounting apertures), with the bolts 256 oriented in generally the same direction. As such, the pump 210 is designed to be assembled via stacking of components (e.g., the unloader 224, the head manifold 222, the piston housing 220) in one direction, without reorienting the pump 210 during assembly, such as on a busy assembly line. In other embodiments, some of the bolts 256 are not oriented in the same direction as other bolts 256, but the pump 210 is still designed to be assembled without reorienting the pump 210 during assembly. In still other embodiments, it is more convenient or efficient to flip the pump 210 during assembly of the pump 210.

Referring now to FIG. 5, the pump 210 is shown as partially disassembled. One of the hex-head bolts 230 has been removed from an end of one of the pumping chambers 226, opening the pumping chamber 226. Within the pumping chamber 226, an aperture 238 is formed on a wall of the pumping chamber 226. In some embodiments, the aperture 238 is an inlet, and an outlet is also formed within the pumping chamber 226, on an opposite side of the pumping chamber 226. In other embodiments the aperture 238 is an outlet.

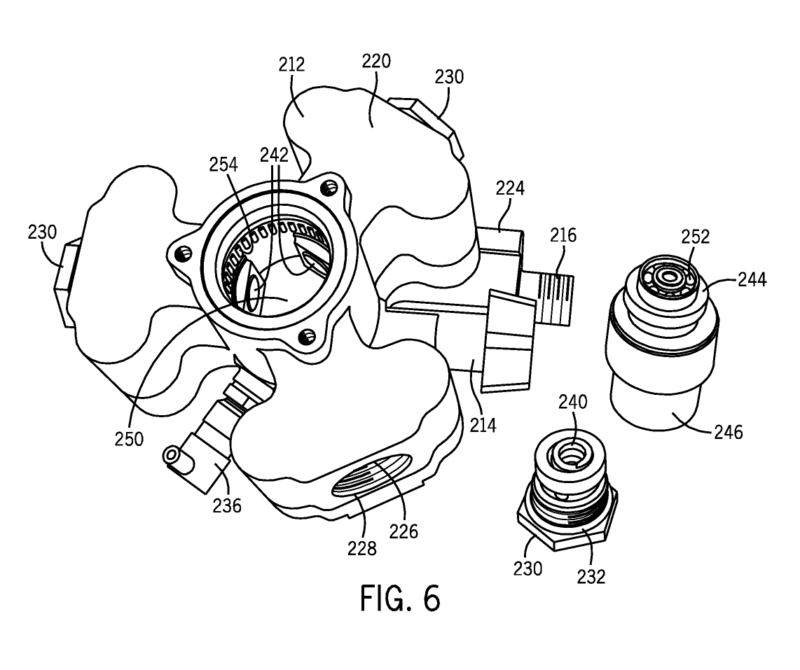

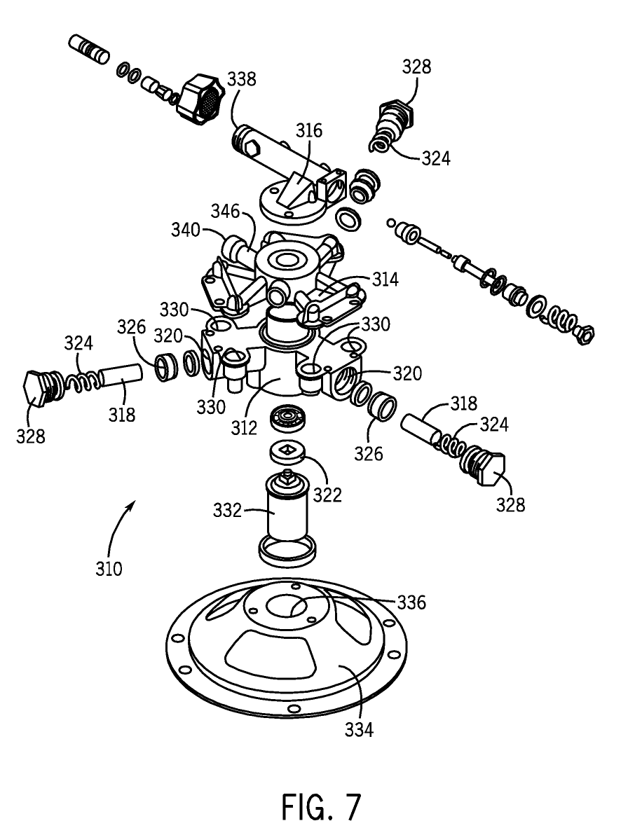

A spring 240 is shown within an interior of the bolt 230. In some embodiments, the spring 240 is used to bias a piston 242 (see FIG. 7) that translates within the pumping chamber 226. The spring 240 biases the piston 242 against a cam 244 (see FIG. 6). In other embodiments, pressure from the flow of water passing through the inlet conduit 214 (e.g. 60 psi from a garden hose) is sufficient to bias the piston 242 against the cam 244, and a spring is not included.

Additionally, a shaft 246 (e.g., camshaft, drive shaft, crankshaft, etc.) of the pump 210 extends from a center of the pump 210. In some embodiments, the shaft 246 includes a key slot 248, a key, or another form of connector for coupling a shaft from the prime mover to the shaft 246 of the pump 210. In some embodiments, the shaft from the prime mover is a power take-off from a combustion engine, which is coupled to the shaft 246 of the pump 210. Within the pump 210, the shaft 246 is attached to the cam 244, and is rotated by the prime mover. In some embodiments, if loading of the shaft 246 exceeds a threshold, the key will shear, decoupling the prime mover and the pump 210 before damaging the pump 210 or prime mover. In other embodiments, a splined coupling, a flange coupling, or another form of connector is used to couple the prime mover to the shaft 246 of the pump 210.

Referring now to FIG. 6, the shaft 246 is shown as removed from a compartment 250 formed within the center of the pump 210. The compartment 250 is designed to contain and support a portion of the shaft 246. The shaft 246 includes the cam 244 and a bearing surface 252, both of which are positioned within the compartment 250 when the pump 210 is fully assembled. Still referring to FIG. 6, the compartment 250 includes portions of the pistons 242 that extend through the walls of the compartment 250, from the pumping chambers 226. When fully assembled, the cam 244 is designed to drive the pistons 242 within the pumping chambers 226, and the springs 240 are designed to bias the pistons 242 toward the cam 244. The bearing surface 252 (e.g., thrust bearing) on the shaft 246 is designed to support axial loads of the shaft 246. The compartment 250 also includes a bearing surface 254 (e.g., roller bearing), which is designed to support lateral loads of the shaft 246.

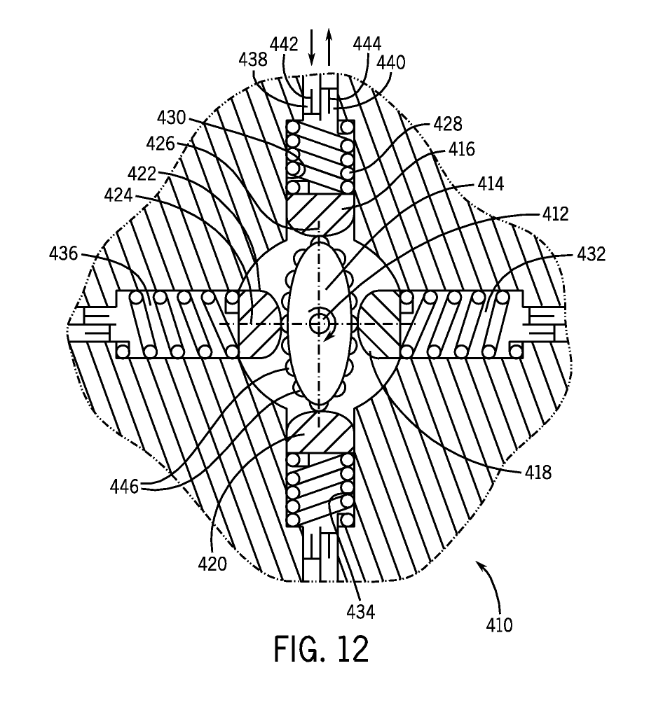

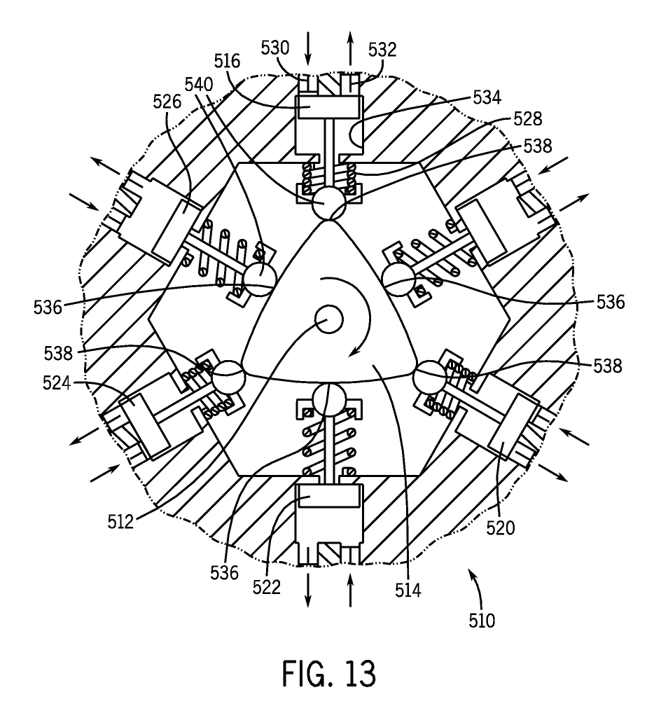

According to an exemplary embodiment, the compartment 250 is sealed when the pump 210 is fully assembled. An amount of grease or other lubricant is added to the compartment 250 during assembly of the pump 210. During operation of the pump 210, the grease lubricates the bearing surfaces 252, 254, the shaft 246, the cam 244, and the pistons 242. According to an exemplary embodiment, the pump 210 is an oil-less pump, such that the lubricant is not motor oil or grease. In still other embodiments, additional bearings (e.g., rolling elements, cylinders, ball bearings, needles, etc.) are attached to the ends of the pistons 242 or to the sides of the cam 244 (see, e.g., bearings 446 as shown in FIG. 12, and bearings 540 as shown in FIG. 13). The additional bearings further reduce friction between the pistons 242 and the cam 244. In such embodiments, grease or other lubricant may not be included in the compartment 250. In still other embodiments, the cam 244 and pistons 242 are lubricated by motor oil, such as motor oil shared with the prime mover.

According to an exemplary embodiment, the cam 244 is elliptical in shape (i.e., the cross section generally forms an ellipse), and rotates about the center of the ellipse. The ellipse of the cam 224 has semimajor and semiminor axes (see, e.g., semimajor axis 426 and semiminor axis 424 as shown in FIG. 12). When the semiminor axis of the cam 244 is aligned with the piston 242 (e.g., a first orientation), the piston 242 is at bottom dead center position. When the semimajor axis of the cam 244 is aligned with a piston 242 (e.g., a second orientation of the cam 244), the cam 244 has pushed the piston 242 to top dead center position. Because of the elliptical shape, the cam 244 drives each piston 242 of the pump 210 twice per revolution of the cam 244. In other embodiments, the shaft 246 includes other types of cams, such as conventional cam lobes having a single eccentric surface for driving the piston.

Referring now to FIG. 7, a water pump 310 includes a piston housing 312, a head manifold 314, and an unloader 316. According to a preferred embodiment, the piston housing 312, the head manifold 314, and the unloader 316 are each integrally formed via die casting. In some embodiments, the piston housing 312, the head manifold 314, and the unloader 316 are formed in castings that are formed from aluminum, impregnated aluminum, brass, composite, plastic, or other materials capable of withstanding the high-pressure flow of water through the water pump 310. For example, the piston housing 312, the head manifold 314, and the unloader 316 are castings that are substantially impermeable to water at pressures exceeding 2000 psi, preferably exceeding 2700 psi, and even more preferably exceeding 3000 psi. Higher pressure water may improve the cleaning or stripping functions of a pressure washer system (see, e.g., pressure washer system 110 as shown in FIG. 1). Forming the water pump 310 from only three main castings may reduce assembly time, decrease manufacturing costs, and improve performance of the pump by reducing leakage between components. In other embodiments, more than three main castings are used to form the water pump 310. In still other embodiments, the piston housing 312, the head manifold 314, and the unloader 316 are machined, formed from powdered metal, or otherwise manufactured.

Still referring to FIG. 7, the water pump 310 includes three sets of pistons 318 (e.g., plungers), springs 324, gaskets 326, and bolts 328—one set for each pumping chamber 320. Check valves 342, 344 may be positioned in ports 330 positioned to the sides of each pumping chamber 320. The check valves 342, 344 are designed to control the flow of water through the pumping chambers 320. The water pump 310 also includes a shaft 332 with an elliptical cam 322 attached to an end of the shaft 332. The shaft 332 extends through an aperture 336 in an adaptor 334, designed to facilitate mounting the water pump 310 to a base plate or other structure. Additionally, the water pump 310 includes the trapped pressure unloader 316, which may include a ball valve biased by a spring and an assortment of related components. The trapped pressure unloader 316 is attached to an outlet 338 of the water pump 310, and a threaded female hose coupling is attached to an inlet 340 of the water pump 310.

The water pump 310 is designed such that the flow rate of water through the water pump 310 may be adjusted in a number of ways. First, the diameter of the pistons 318 and the pumping chambers 320 of the water pump 310 may be increased or decreased to alter the volume of water driven per cycle. For example, the head manifold 314 and the unloader 316 may be attached to a larger piston housing (e.g., deeper) with correspondingly wider pistons to produce an increased-capacity water pump. In such embodiments, the same head manifold 314 and unloader 316 may be used with differently sized piston housings, providing a range of pumps with varied capacities.

Second, the rate and torque provided by the prime mover may be increased or decreased (e.g., throttling or idling an engine). Or a more- or less-powerful prime mover may be coupled to the water pump 310.

Third, the dimensions of the elliptical cam 322 of the water pump 310 may be adjusted. In some embodiments, an elliptical cam with a greater semimajor axis may be used to increase the flow rate of the water pump 310, by increasing the translational amplitude of the piston 318 (i.e., the distance that the piston 318 travels between top dead center and bottom dead center positions). Alternatively, the semiminor axis of the elliptical cam 322 may be reduced in length, also resulting in an increased stroke length of the piston 318. According to an exemplary embodiment, the diameter of the pistons 318 and pumping chambers 320 are optimized with respect to the dimensions of the elliptical cam 322 in order to improve the efficiency of the water pump 310.

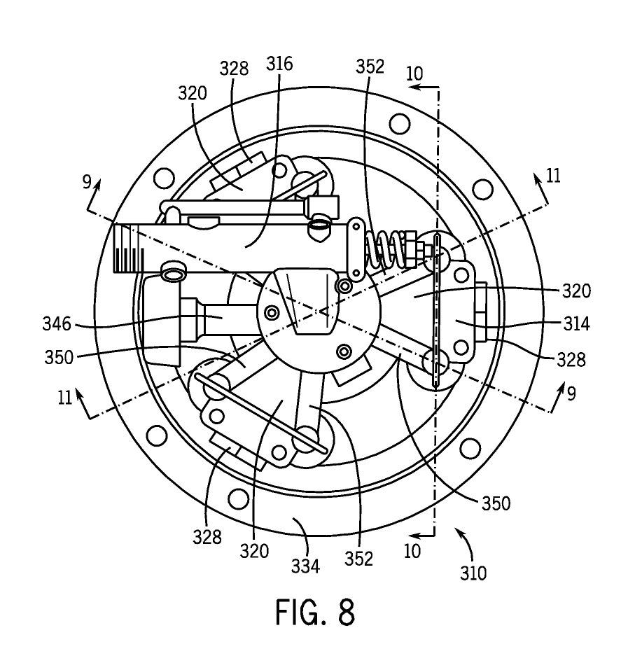

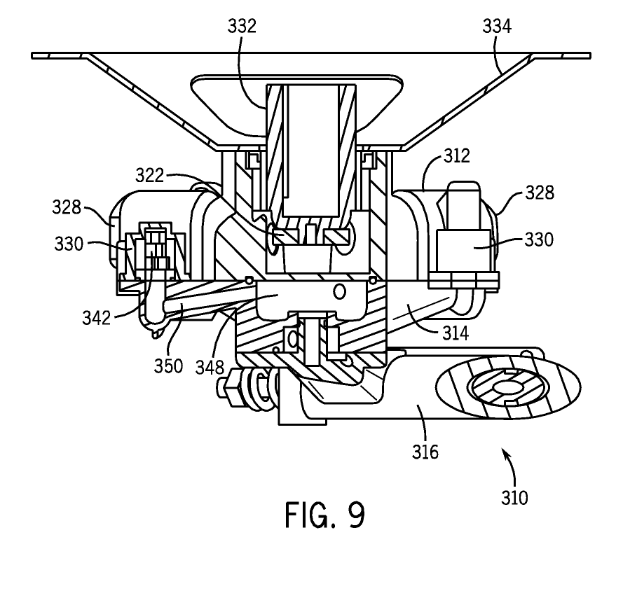

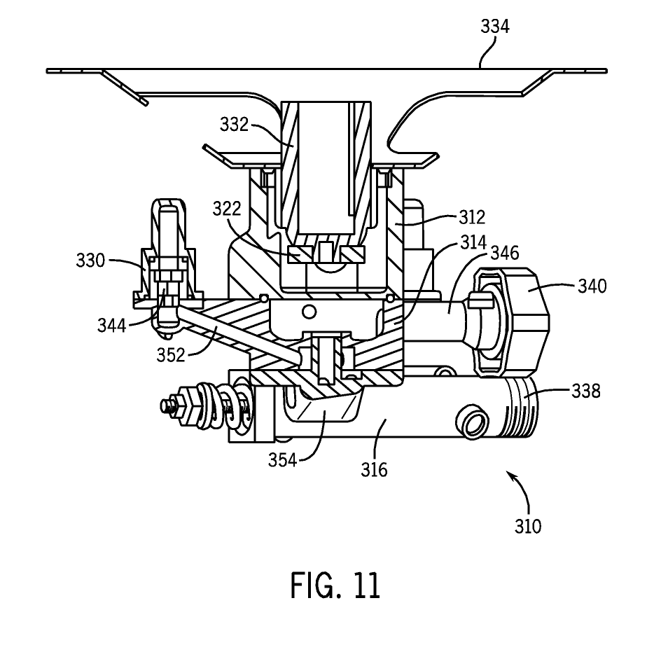

Referring now to FIGS. 8-11, a flow path for the flow of water through the water pump 310 is shown, according to an exemplary embodiment. FIG. 8 shows a top-down view of the water pump 310 from the perspective of the unloader 316 on the top and the adaptor 334 on the bottom. The water pump 310 includes the inlet 340, the outlet 338, and three pumping chambers 320. The inlet 340 is coupled to a conduit 346 that leads to an inlet manifold 348 (see FIG. 9). Referring to FIG. 8, for each of the pumping chambers 320, an inlet conduit 350 extends from the inlet manifold 348 (see FIG. 9) in the center of the water pump 310 to the side of each pumping chamber 320. Further, an outlet conduit 352 extends from the opposite side of each pumping chamber 320, to an outlet manifold 354 (see FIG. 11) in the center of the water pump 310.

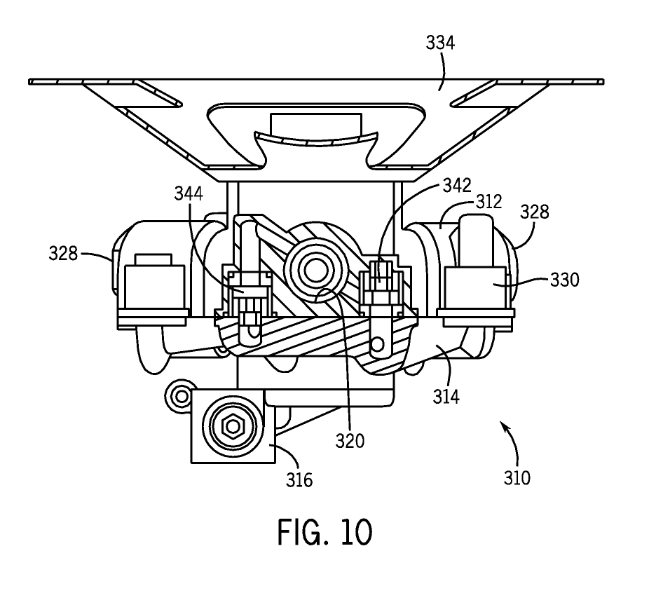

FIG. 9 shows the flow path of water from the inlet manifold 348 within the center of the water pump 310, through the inlet conduit 350, past a first check valve 342, and into one of the pumping chambers 320. FIG. 10 shows the flow path from the first check valve 342, into the pumping chamber 320, through the pumping chamber 320, and then (under high pressure) out of the pumping chamber 320 past a second check valve 344. FIG. 11 shows the flow path from the second check valve 344, through the outlet conduit 352, and into the outlet manifold 354 extending into the unloader 316. The water then combines with the high pressure water from the other pumping chambers 320 in the unloader 316, and is directed out of the water pump 310. In other embodiments, the water pump 310 has a single check valve coupled to the inlet manifold and a single check valve coupled to the outlet manifold, in place of the check valves 342, 344 adjacent to each of the pumping chambers 320.

Referring now to FIG. 12, a pump 410 includes an elliptical cam 414 and four pistons 416, 418, 420, 422. The elliptical cam rotates about the center 412 of the ellipse, such that the pistons 416, 418, 420, 422 travel along the periphery of the elliptical cam 414. The elliptical cam 414 drives the pistons 416, 418, 420, 422 when the elliptical cam rotates from the semiminor axis 424 (short axis) to the semimajor axis 426 (long axis) of the ellipse, which occurs twice per rotation of the elliptical cam 414. The pistons recover (e.g., by way of a biasing spring 428) when the elliptical cam 414 rotates toward the semiminor axis 424 of the ellipse. The pistons 416, 418, 420, 422 are designed to translate back and forth within corresponding pumping chambers 430, 432, 434, 436, as the elliptical cam 414 drives the pistons 416, 418, 420, 422. The pump 410 further includes inlet and outlet conduits 438, 440 and check valves 442, 444 coupled to the pumping chambers 430, 432, 434, 436, opposite to the pistons 416, 418, 420, 422.

According to an exemplary embodiment, the elliptical cam 414 includes bearings 446 coupled to the sides of the elliptical cam 414. In some embodiments, the bearings 436 include a rolling element (e.g., ball, cylinder, needle, tapered roller element, or other rolling element). As shown in FIG. 12, the bearings 446 are attached to the cam 414 on opposite side of the cam 414 along the semimajor axis 426 of the ellipse. In some embodiments, roller bearings fully surround the cam 414 on all sides of the elliptical periphery. In still other embodiments, the pistons include bearings (e.g., rolling-element bearing), and the cam does not include bearings.

The pistons 416, 418, 420, 422 of the pump 410 are arranged in opposing pairs of pistons 416, 420 and 418, 422. As the elliptical cam 414 rotates, the cam 414 drives the pistons 416, 418, 420, 422 of the piston pairs 416, 420 and 418, 422 in opposite directions. The momentum associated with the movement of one piston 416, 418 of the piston pairs 416, 420 and 418, 422 is offset by the oppositely-directed momentum of the other piston 420, 422 of the piston pairs 416, 420 and 418, 422. For example, as the semimajor axis 426 of the elliptical cam 414 is aligned with the piston 416, the semimajor axis 426 is simultaneously aligned with the piston 420. As such, the pistons 416, 420 translate in opposite directions relative to each other. The result of arranging the opposing pairs of pistons 416, 420 and 418, 422 is that vibrations of the water pump 310 (e.g., wobbling, shaking, etc.) may be reduced, which could increase the life of pump components and reduce noise produced by the water pump 310 during use.

Referring to FIG. 13, a water pump 510 includes a triangular cam 514 and six pistons 516, 518, 520, 522, 524, 526. Springs 528 are used to bias the pistons 516, 518, 520, 522, 524, 526 toward the triangular cam 514. Check valves 530, 532 control the flow of water into and out of the pumping chamber 534. The triangular cam 514 rotates about a center 512 of the triangle, and drives the pistons 516, 518, 520, 522, 524, 526 when the point of contact between the pistons 516, 518, 520, 522, 524, 526 and the triangular cam 514 rotates from the center of a side 536 of the triangle to a vertex 538 of the triangle, which occurs three times per rotation of the triangular cam 514. The pistons 516, 518, 520, 522, 524, 526 recover by way of the biasing springs 528 when the triangular cam 514 rotates toward the center of a side 536 of the triangle. According to an exemplary embodiment, the spring 528 is not within the pumping chamber 534. In some embodiments, bearings 540 are attached to the pistons 516, 518, 520, 522, 524, 526 to reduce friction between the triangular cam 514 and the pistons 516, 518, 520, 522, 524, 526.

The pistons 516, 518, 520, 522, 524, 526 are at top dead center position as the vertices 538 of the triangular cam 514 contact the pistons 516, 518, 520, 522, 524, 526 (i.e., in the center of the base of the pistons 516, 518, 520, 522, 524, 526). Conversely the pistons 516, 518, 520, 522, 524, 526 are at bottom dead center position when the centers of each of the sides 536 of the triangular cam 514 contact the pistons 516, 518, 520, 522, 524, 526. The flow rate of the water pump 510 may be altered by adjusting the stroke length of the pistons 516, 518, 520, 522, 524, 526. The stroke length of the pistons 516, 518, 520, 522, 524, 526 can be increased or decreased by indenting or protruding the sides 536 of the triangular cam 514, or by lengthening or shortening the distance that the vertices 538 extend from the center 512 of the triangle. In such cases, the triangular cam 514 may not be a perfect geometric triangle, but is still generally of a triangular shape.

Still referring to FIG. 13, the pistons 516, 518, 520, 522, 524, 526 are arranged in opposing triplets 516, 520, 524 and 518, 522, 526. As the triangular cam 514 rotates, the three vertices 538 of the triangular cam 514 simultaneously drive three pistons 516, 520, 524 or 518, 522, 526. The change in momentum produced by the translation of each piston 516 and 518 is offset by the other two pistons 520, 524 and 522, 526 in the opposing triplets 516, 520, 524 and 518, 522, 526. The result of arranging the pistons 516, 518, 520, 522, 524, 526 in the opposing triplets 516, 520, 524 and 518, 522, 526 is that vibrations of the water pump 510 (e.g., wobbling, shaking, etc.) may be reduced, which could increase the life of pump components and reduce noise produced by the water pump 510 during use. In some embodiments, a triangular cam (see e.g., triangular cam 514 as shown in FIG. 13) may also be used with the pumps 210, 310 (e.g., triplex pump) in order to produce the benefits of opposing triplets.

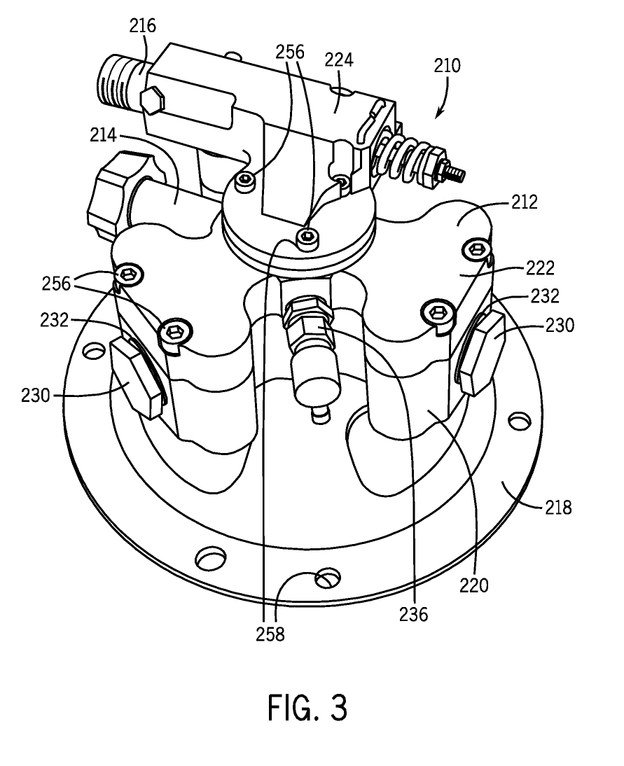

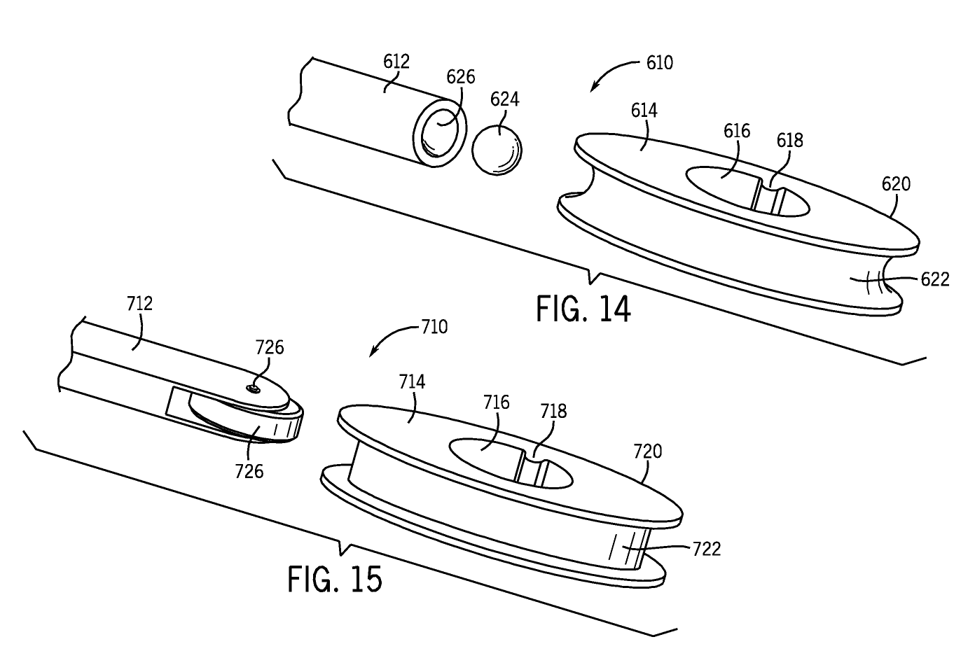

Referring to FIG. 14, a coupling 610 joining a piston 612 and a cam 614 includes a rolling element in the form of a ball 624. The cam 614 is elliptical, and includes a port 616 therein, the port 616 optionally having a key 618 or spline for receiving and coupling to a power take-off of a small engine, or other shaft. The cam 614 is configured to operate within a water pump (e.g., pump 210, as shown in FIG. 3-6, or pump 310, as shown in FIG. 7). The cam 614 further includes a channel 622 extending around the periphery 620 of the cam 614. The channel 622 is contoured to receive one or more spherical rolling elements, such as the ball 624. According to an exemplary embodiment, the ball 624 is coupled to the piston 612 via the cup 626 (e.g., ball-in-socket joint), where the ball 624 rolls in the cup 626 and through the channel 622 as the piston 612 moves relative to the cam 614. According to an exemplary embodiment, the ball 624 rolling element reduces frictional forces between the cam 614 and the piston 612, improving efficiency of the pump and reducing lubrication requirements for the pump.

Referring to FIG. 15, a coupling 710 joining a piston 712 and a cam 714 also includes a rolling element, which is in the form of a roller 724 coupled to the piston 712 via a pin 726. The cam 714 is elliptical, and includes a port 716 having a key 718. The cam 714 further includes a channel 722 contoured to receive the roller 724, the channel 722 extending circumferentially around the periphery 720 of the cam 714.

The construction and arrangements of the water pump, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. In some embodiments, a piston is coupled to the shaft of the pump via a connecting rod, similar to a piston in a typical combustion engine, and springs are not used to bias the piston. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A high-pressure water pump for a pressure washer system, comprising:
an elliptical cam configured to be powered by a prime mover, the elliptical cam rotatable between a first orientation and a second orientation;
a piston configured to be driven within a chamber by the elliptical cam, wherein during operation of the water pump, a flow of water enters the chamber through an inlet when the elliptical cam rotates to the first orientation, and the flow of water exits the chamber at an increased pressure through an outlet when the elliptical cam rotates to the second orientation; and
an unloader configured to control pressure fluctuations in the flow of water, wherein the unloader is coupled to the outlet such that the flow of water exits the water pump through the unloader.

2. The water pump of claim 1, further comprising an intake conduit having a garden hose connector coupled thereto, wherein the flow of water enters the water pump through the intake conduit.

3. The water pump of claim 2, further comprising a compartment in which the elliptical cam rotates and drives the piston, wherein the compartment contains a lubricant other than oil.

4. The water pump of claim 2, further comprising a bearing positioned between the elliptical cam and the piston when the elliptical cam is in the second orientation.

5. The water pump of claim 4, wherein the bearing comprises a rolling element.

6. The water pump of claim 2, wherein the water pump further comprises a housing, and wherein the housing comprises a piston housing casting fastened to a head manifold casting fastened to an unloader casting.

7. The water pump of claim 6, wherein the piston housing casting, the head manifold casting, and the unloader casting each include mounting apertures positioned therein such that bolts inserted through the head manifold casting fasten the head manifold casting to the piston housing casting, and such that additional bolts inserted through the unloader casting fasten the unloader casting to the head manifold casting.

8. The water pump of claim 2, wherein the piston is a first piston, and the water pump further comprises a second piston, wherein the first piston and the second piston are positioned on opposite sides of the elliptical cam such that movement of the first piston is oppositely matched by movement of the second piston.

9. The water pump of claim 8, further comprising a third and a fourth piston positioned on opposite sides of the elliptical cam relative to each other.

10. The water pump of claim 2, wherein the elliptical cam is configured to be replaced by another elliptical cam having a semimajor axis of another length, whereby a flow rate of the water pump is altered.

11. A water pump, comprising:
a cam configured to be powered by a prime mover, the cam rotatable between a first orientation and a second orientation;
a piston configured to be driven within a chamber by the cam;
a compartment in which the cam rotates and drives the piston; and
a bearing positioned between the cam and the piston when the cam is in the second orientation.

12. The water pump of claim 11, wherein the bearing comprises a rolling element.

13. The water pump of claim 12, wherein the cam is an elliptical cam.

14. The water pump of claim 13, wherein the bearing is attached to the piston.

15. The water pump of claim 13, wherein the bearing is attached to the cam.

16. The water pump of claim 13, wherein the piston is a first piston, and the water pump further comprises a second piston, wherein the first piston and the second piston are positioned on opposite sides of the elliptical cam such that movement of the first piston is oppositely matched by movement of the second piston.

17. The water pump of claim 16, further comprising a third and a fourth piston positioned on opposite sides of the elliptical cam relative to each other.

18. The water pump of claim 17, further comprising a pump head configured to be impermeable to water at pressures exceeding 2000 psi.

19. A method of assembling a water pump for a pressure washer system, comprising:
providing a first casting forming a piston housing;
providing a second casting forming a head manifold;
fastening the second casting on top of the first casting;
providing a third casting forming an unloader; and
fastening the third casting on top of the second casting, wherein the steps of fastening the second casting and fastening of the third casting do not require reorienting the first casting, the second casting, or the third casting, whereby the orientation of the water pump need not be changed on an assembly line during assembly.

20. The method of claim 19, wherein the step of fastening the second casting further includes bolting the second casting on top of the first casting, and wherein the step of fastening the third casting further includes bolting the third casting on top of the second casting.
